(19) United States
(12) Patent Application Publication
(10) Pub. No.: US 2019/0040970 A1
(43) Pub. Date: Feb. 7, 2019

(54) COMPOSITE VALVE AND SOLENOID VALVE USING THE SAME

(71) Applicant: KYB Corporation, Tokyo (JP)

(72) Inventor: Toru TAKEUCHI, Kanagawa (JP)

(73) Assignee: KYB Corporation, Tokyo (JP)

(21) Appl. No.: 15/757,703

(22) PCT Filed: Aug. 12, 2016
(86) PCT No.: PCT/JP2016/073781

§ 371 Date: Mar. 6, 2018

(30) Foreign Application Priority Data
Sep. 7, 2015 (JP) 2015-175891

(51) Int. Cl. F16K 31/06; F16K 1/44

(52) U.S. Cl. CPC F16K 31/06; F16K 1/443

(57) ABSTRACT

A composite valve provided in a solenoid valve includes a sliding hole having a first port and a second port, a sub-port communication passage branched from the sliding hole and having a third port, a first valve body allowing only the flow of hydraulic oil from the first port to the second port, and a second valve body allowing only the flow of the hydraulic oil from the third port to the second port. The first valve body and the second valve body are displaced along the sliding hole formed to be straight. When the first valve body is opened, the hydraulic oil is introduced from the first port to the second port through a through hole provided in the second valve body.

### TECHNICAL FIELD

The present invention relates to a composite valve and a solenoid valve using the same.

### BACKGROUND ART

In hydraulically operated construction machinery and industrial machinery, a solenoid valve is used which controls a flow rate of hydraulic oil according to an electromagnetic force.

A solenoid valve including a main valve for changing a communication opening degree between a main port and a sub-port and a control pressure chamber for biasing the main valve toward a valve closing direction is described in JP2002-106743A and JP2004-308909A. The solenoid valve further includes two valve bodies, i.e. a valve body for allowing the flow of hydraulic oil from the main port to the control pressure chamber and a valve body for allowing the flow of the hydraulic oil from the sub-port to the control pressure chamber.

### SUMMARY OF INVENTION

In the solenoid valve disclosed in JP2002-106743A, a passage allowing communication between the main port and the control pressure chamber and a passage allowing communication between the sub-port and the control pressure chamber are respectively separately provided, and the valve body for allowing the flow of the hydraulic oil to the control pressure chamber is arranged in each of these passages. As just described, in the solenoid valve disclosed in JP2002-106743A, since the two passages, in which the valve bodies are arranged, need to be respectively independently formed, the entire solenoid valve including the ports is enlarged.

Further, in the solenoid valve disclosed in JP2004-308909A, two valve bodies for allowing the flow of the hydraulic oil to the control pressure chamber are built in a main valve. The valve bodies are respectively arranged in a flow passage extending in an axial direction of the main valve and a flow passage extending in a radial direction of the main valve. As just described, in the solenoid valve disclosed in JP2004-308909A, since an outer diameter of the main valve needs to be increased in order to include the two valve bodies, the solenoid valve is enlarged.

The present invention aims to make a composite valve including two valve bodies and a solenoid valve using the same compact.

According to one aspect of the present invention, a composite valve includes a first flow passage connecting a first port and a second port, the first flow passage being formed to be straight; a second flow passage branched from the first flow passage, the second flow passage including a third port; a first valve body configured to allow only the flow of working fluid from the first port to the second port; and a second valve body configured to allow only the flow of the working fluid from the third port to the second port. The first valve body includes a first valve portion configured to be seated on a first seat portion formed in the first flow passage. The second valve body includes a second valve portion configured to be seated on a second seat portion formed in the first flow passage. The first valve body and the second valve body are displaced along the first flow passage. The working fluid is introduced from the first port to the second port through a through hole provided in the second valve body when the first valve body is opened.

### BRIEF DESCRIPTION OF DRAWINGS

FIG. 1 is a sectional view of a solenoid valve according to a first embodiment of the present invention;

FIG. 2 is a view enlargedly showing a composite valve of FIG. 1;

FIG. 3 is a sectional view of a solenoid valve according to a second embodiment of the present invention; and

FIG. 4 is a view enlargedly showing a composite valve of FIG. 3.

### DESCRIPTION OF EMBODIMENTS

Hereinafter, embodiments of the present invention are described with reference to the accompanying drawings.

### First Embodiment

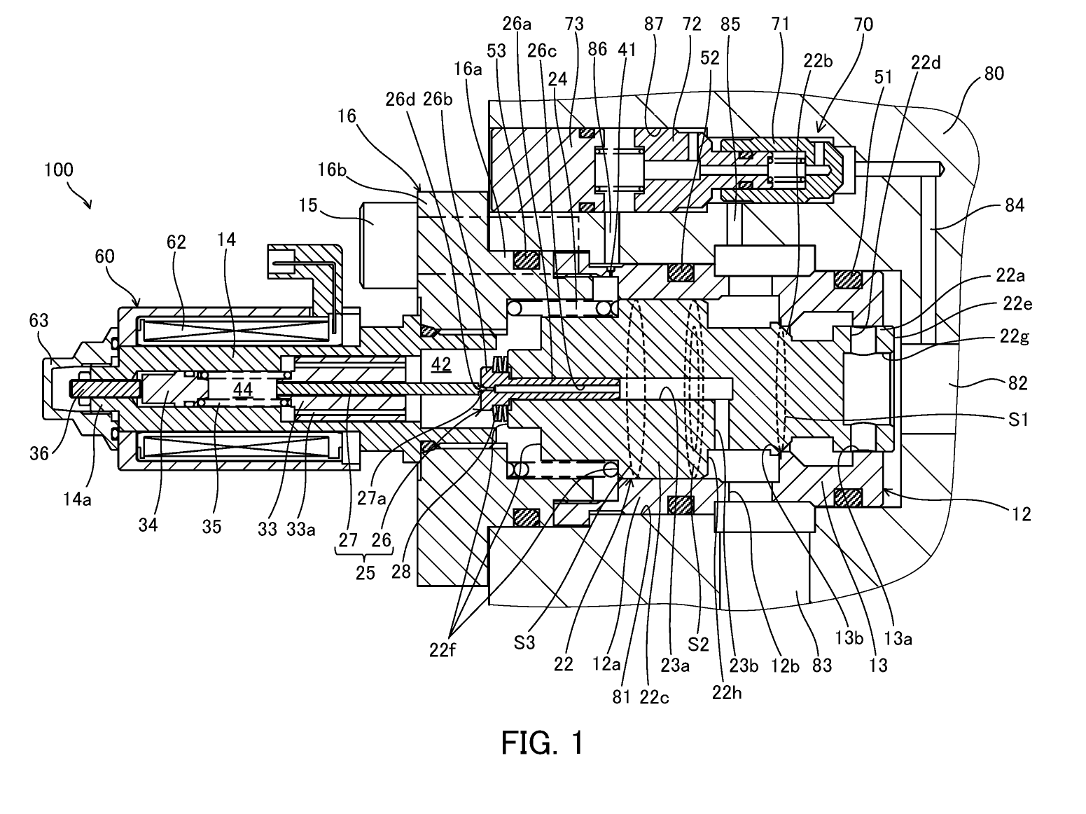

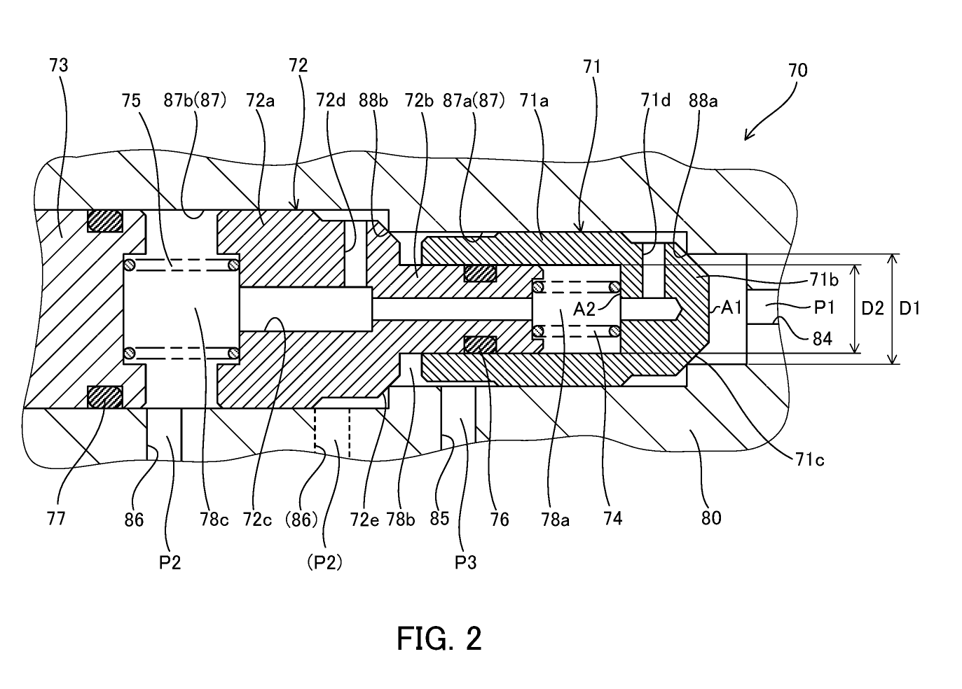

A solenoid valve 100 according to a first embodiment of the present invention is described with reference to FIGS. 1 and 2.

The solenoid valve 100 shown in FIG. 1 is provided in a construction machine, an industrial machine or the like and controls a flow rate of working fluid supplied from an unillustrated fluid pressure source to an actuator (load) and a flow rate of the working fluid discharged from the actuator to a tank or the like. This solenoid valve 100 is a unidirectional flow control valve for controlling a flow rate of the working fluid flowing from a main port 82 to a sub-port 83.

The solenoid valve 100 is inserted and fixed in a non-penetrating insertion hole 81 provided in a valve block 80. The valve block 80 includes the main port 82 having one end opening in the bottom surface of the insertion hole 81 and the other end opening in the outer surface of the valve block 80 and connected to a pump serving as the fluid pressure source through unillustrated piping, and the sub-port 83 having one end opening in the side surface of the insertion hole 81 and the other end opening in the outer surface of the valve block 80 and connected to the actuator through unillustrated piping.

In the solenoid valve 100, hydraulic oil is used as the working fluid. The working fluid is not limited to the hydraulic oil and may be another incompressible fluid or compressible fluid.

The solenoid valve 100 includes a main valve 22 changing a communication opening degree between the main port 82 and the sub-port 83, a hollow cylindrical sleeve 12 fixed in the insertion hole 81 and having the main valve 22 slidably inserted thereinto, a control pressure chamber 42 having the hydraulic oil introduced thereto from the main port 82 or the sub-port 83 and biasing the main valve 22 toward a valve closing direction, an auxiliary valve 27 changing a communication opening degree between the control pressure chamber 42 and the sub-port 83, a solenoid portion 60 displacing the auxiliary valve 27 according to a supplied current, and a composite valve 70 selectively connecting the main port 82 and the sub-port 83 to the control pressure chamber 42.

The sleeve 12 includes a sliding support portion 12a slidably supporting the outer peripheral surface of the main valve 22, and a seat portion 13 on which the main valve 22 is seated.

Two seat portions, i.e. a circular-hole-shaped first seat portion 13a and a truncated conical second seat portion 13b, are successively formed on the inner periphery of the seat portion 13 from the side of the main port 82. A center axis of the first seat portion 13a and that of the second seat portion 13b coincide with a center axis of the sleeve 12.

A plurality of communication holes 12b allowing communication between a space in the sleeve 12 and the sub-port 83 are formed between the second seat portion 13b and the sliding support portion 12a while being circumferentially spaced apart.

O-rings 51, 52 are respectively arranged on the outer periphery of the seat portion 13 and that of the sliding support portion 12a to sandwich the communication holes 12b. Connecting parts of the communication holes 12b and the sub-port 83 are sealed by these two O-rings 51, 52 compressed between the sleeve 12 and the insertion hole 81. Particularly, the communication of the main port 82 and the sub-port 83 through a clearance between the sleeve 12 and the insertion hole 81 is prevented by the O-ring 51 provided on the outer periphery of the seat portion 13.

The main valve 22 is a cylindrical member and so arranged in the sleeve 12 that one end surface 22e is located on the side of the seat portion 13 and a sliding portion 22c is slidably supported on the sliding support portion 12a.

A cylindrical spool valve 22a to be slidably inserted into the first seat portion 13a is formed on the side of the one end surface 22e of the main valve 22, and a truncated conical poppet valve 22b to be seated on the second seat portion 13b is formed between the spool valve 22a and the sliding portion 22c. Further, the main valve 22 is formed with a step portion 22h between the poppet valve 22b and the sliding portion 22c, and the step portion 22h having a surface perpendicular to an axial direction of the main valve 22. A pressure of the sub-port 83 acts on the step portion 22h through the communication holes 12b.

On the one end surface 22e of the main valve 22, a recess 22g communicating with the main port 82 is formed on the same axis as the spool valve 22a. A plurality of through holes 22d each having one end opening in a sliding surface against the first seat portion 13a and the other end opening in the inner peripheral surface of the recess 22g are formed in the spool valve 22a while being circumferentially spaced apart.

Each through hole 22d closed by the first seat portion 13a is gradually opened as the spool valve 22a moves in a separating direction of the poppet valve 22b and the second seat portion 13b. That is, the area of each through hole 22d exposed from the first seat portion 13a changes according to a movement amount of the spool valve 22a. As just described, the flow rate of the hydraulic oil flowing from the main port 82 to the sub-port 83 can be controlled by changing an opening area of each through hole 22d.

Each through hole 22d is arranged not to be completely closed by the first seat portion 13a even if the poppet valve 22b comes into contact with the second seat portion 13b. That is, the opening area of each through hole 22d is smallest at a valve closing position where the poppet valve 22b comes into contact with the second seat portion 13b and gradually increases as the poppet valve 22b is displaced in a valve opening direction.

It should be noted that each through hole 22d may be arranged to be closed by the first seat portion 13a until the poppet valve 22b is separated to a certain degree from the second seat portion 13b. In this case, the flow rate of the hydraulic oil can be set substantially at zero until the main valve 22 is displaced to a certain degree.

Another end surface 22f of the main valve 22 is facing the control pressure chamber 42 defined by the main valve 22, the sleeve 12 and the solenoid portion 60.

The valve block 80 further includes a sliding hole 87 serving as a first flow passage formed in parallel to the insertion hole 81, a main port communication passage 84 having one end opening in the bottom surface of the sliding hole 87 and the other end connected to the main port 82, a sub-port communication passage 85 serving as a second flow passage having one end opening in the side surface of the sliding hole 87 and the other end connected to the sub-port 83, and a control pressure chamber communication passage 86 having one end opening in the side surface of the sliding hole 87 and the other end connected to the control pressure chamber 42. The control pressure chamber communication passage 86 communicates with the control pressure chamber 42 through an introducing hole 41 formed in the sleeve 12 and functioning as an orifice. A first valve body 71 and a second valve body 72 of the composite valve 70 to be described later are slidably housed in the sliding hole 87.

A main return spring 24 is provided in a compressed state between the main valve 22 and the solenoid portion 60 in the control pressure chamber 42.

A biasing force of the main return spring 24 acts in a direction to close the main valve 22. Further, a pressure of the main port 82 acts on a first valve opening pressure receiving surface S1 equivalent to a cross-section in the second seat portion 13b of the main valve 22 and acts in a direction to open the main valve 22. Further, a pressure of the sub-port 83 acts on a second valve opening pressure receiving surface S2 equivalent to a cross-section in the step portion 22h of the main valve 22 and acts in a direction to open the main valve 22. Further, a pressure in the control pressure chamber 42 acts on a valve closing pressure receiving surface S3 equivalent to a cross-section in the sliding portion 22c and acts in a direction to close the main valve 22.

Thus, the main valve 22 is displaced in the valve opening direction if a resultant force of a thrust force by the pressure of the main port 82 acting on the first valve opening pressure receiving surface S1 and a thrust force by the pressure of the sub-port 83 acting on the second valve opening pressure receiving surface S2 exceeds a resultant force of a thrust force by the pressure in the control pressure chamber 42 acting on the valve closing pressure receiving surface S3 and the biasing force of the main return spring 24. The main valve 22 is displaced in the valve closing direction if the above-mentioned former resultant force falls below the above-mentioned latter resultant force.

The main valve 22 further includes a first communication passage 23a and a second communication passage 23b allowing communication between the control pressure chamber 42 and the sub-port 83.

The first communication passage 23a is a non-penetrating hole having one end opening in the other end surface 22f, and formed in the main valve 22 so that a center axis thereof coincides with that of the main valve 22. The second communication passage 23b is formed along a radial direction of the main valve 22 and has one end communicating with the first communication passage 23a and the other end opening in the outer peripheral surface of the main valve 22. The other end of the second communication passage 23b is arranged to constantly communicate with the communication holes 12b in a range where the main valve 22 is displaced in the axial direction.

The main valve 22 is further provided with a pilot pressure control valve 25 controlling the pressure in the control pressure chamber 42 by adjusting a communicating state between the control pressure chamber 42 and the first communication passage 23a.

The pilot pressure control valve 25 includes a hollow cylindrical pressure compensation sleeve 26 formed with a sub-seat portion 26d, and the cylindrical auxiliary valve 27 having one end provided with a sub-poppet valve 27a to be seated on the sub-seat portion 26d.

The pressure compensation sleeve 26 includes a sliding portion 26a to be slidably inserted into the first communication passage 23a, a flange portion 26b arranged to face the control pressure chamber 42 and having a larger outer diameter than the sliding portion 26a, and a through hole 26c formed to penetrate from the flange portion 26b to the sliding portion 26a in the axial direction. The sub-seat portion 26d is formed on an opening end of the through hole 26c open in the flange portion 26b. Thus, the first communication passage 23a and the control pressure chamber 42 communicate through the sub-seat portion 26d and the through hole 26c.

A pressure compensation spring 28 composed of a plurality of disc springs is interposed between the flange portion 26b and the other end surface 22f of the main valve 22. The pressure compensation sleeve 26 is biased in a direction away from the main valve 22 by the pressure compensation spring 28.

When the sub-poppet valve 27a and the sub-seat portion 26d come into contact, the communication between the control pressure chamber 42 and the first communication passage 23a is blocked. On the other hand, when the sub-poppet valve 27a is separated from the sub-seat portion 26d and a clearance is formed between the sub-poppet valve 27a and the sub-seat portion 26d, the control pressure chamber 42 and the first communication passage 23a communicate. Thus, the hydraulic oil in the control pressure chamber 42 is discharged to the sub-port 83 through the first communication passage 23a and the second communication passage 23b. Although the hydraulic oil is introduced to the control pressure chamber 42 through the main port communication passage 84 and the control pressure chamber communication passage 86, the inflow of the hydraulic oil into the control pressure chamber 42 is limited by the introducing hole 41. As a result, the pressure in the control pressure chamber 42 decreases. In this way, the pressure in the control pressure chamber 42 is controlled by the pilot pressure control valve 25.

The size of the clearance between the sub-poppet valve 27a and the sub-seat portion 26d is adjusted by changing the position of the auxiliary valve 27 with respect to the pressure compensation sleeve 26 in the axial direction. Since the axial position of the auxiliary valve 27 is controlled by the solenoid portion 60, the size of this clearance is controlled by the solenoid portion 60.

The solenoid portion 60 includes a coil 62 generating a magnetic attraction force by a current supplied thereto, a bottomed tube-shaped solenoid tube 14 having the coil 62 provided on an outer periphery, and a coupling member 16 coupling the solenoid tube 14 and the sleeve 12.

A cylindrical tubular plunger 33 having the auxiliary valve 27 fixed at an axial center and attracted by the magnetic attraction force generated by the coil 62, a cylindrical retainer 34 movable in the axial direction and a sub-return spring 35 interposed in a compressed state between the plunger 33 and the retainer 34 are provided in the solenoid tube 14. The plunger 33 is biased by the sub-return spring 35 in such a direction that the sub-poppet valve 27a formed on the tip of the auxiliary valve 27 is seated on the sub-seat portion 26d.

The plunger 33 is formed with a plurality of through holes 33a penetrating in the axial direction, and a spring chamber 44 in which the sub-return spring 35 is arranged communicates with the control pressure chamber 42 through the through holes 33a. Thus, a pressure in the spring chamber 44 is equivalent to the pressure in the control pressure chamber 42 and a biasing force of the sub-return spring 35 and the pressure in the spring chamber 44 act in a direction to press the sub-poppet valve 27a against the sub-seat portion 26d.

An adjustment screw 36 is threadably engaged with an end part 14a of the solenoid tube 14 while penetrating through the end part 14a in the axial direction. One end of the adjustment screw 36 is in contact with the retainer 34 in the spring chamber 44. When the adjustment screw 36 is rotated, the axial position of the retainer 34 is changed and the biasing force of the sub-return spring 35 varies. As just described, by rotating the adjustment screw 36, an initial load of the sub-return spring 35 acting on the plunger 33 can be changed. The other end of the adjustment screw 36 projecting from the solenoid tube 14 is covered by a cover 63 attached to the solenoid tube 14.

The coupling member 16 includes an inserting portion 16a to be inserted into the insertion hole 81 of the valve block 80, and a flange portion 16b for fixing the solenoid valve 100 to the valve block 80. The coupling member 16 couples the sleeve 12 and the solenoid tube 14 by having the solenoid tube 14 threadably engaged with the inner peripheral surface of the flange portion 16b and having the sleeve 12 threadably engaged with the inserting portion 16a.

An O-ring 53 serving as a sealing member is arranged on the outer periphery of the inserting portion 16a. Communication between the inside and outside of the insertion hole 81 is blocked by the O-ring 53 compressed between the coupling member 16 and the insertion hole 81. Thus, the leakage of the hydraulic oil in the insertion hole 81 to outside is prevented and the entrance of water, dust and the like into the insertion hole 81 from outside is prevented.

A plurality of unillustrated bolt holes into which bolts 15 are inserted are formed in the flange portion 16b, and the flange portion 16b is fastened to the valve block 80 via the bolts 15. By fastening the coupling member 16 to the valve block 80, the solenoid valve 100 is fixed to the valve block 80.

Next, the composite valve 70 is described with reference to FIGS. 1 and 2.

The composite valve 70 includes the sliding hole 87 serving as the first flow passage having a first port P1 and a second port P2, the sub-port communication passage 85, serving as the second flow passage, formed to be branched from the sliding hole 87 and having a third port P3, the first valve body 71 allowing only the flow of the hydraulic oil from the first port P1 to the second port P2, and the second valve body 72 allowing only the flow of the hydraulic oil from the third port P3 to the second port P2. The first port P1 is connected to the main port 82 through the main port communication passage 84, and the second port P2 is connected to the control pressure chamber 42 through the control pressure chamber communication passage 86.

The first and second valve bodies 71, 72 are arranged side by side in series along the sliding hole 87 formed to be straight. It should be noted that the sliding hole 87 is not limited to a straight shape and may have a bent part. Also in this case, the first and second valve bodies 71, 72 are arranged in series along the sliding hole 87.

As shown in FIG. 2, the sliding hole 87 includes a first sliding hole 87a in which the first valve body 71 is housed, and a second sliding hole 87b in which the second valve body 72 is housed. The first and second sliding holes 87a, 87b are coaxially formed, and an inner diameter of the second sliding hole 87b is larger than that of the first sliding hole 87a. A plug 73 is mounted in an opening end of the sliding hole 87, and an O-ring 77 compressed between the plug 73 and the sliding hole 87 is arranged on the outer periphery of the plug 73. Since the opening end of the sliding hole 87 is sealed by the O-ring 77, the leakage of the hydraulic oil in the sliding hole 87 to outside is prevented and the entrance of water, dust and the like into the sliding hole 87 from outside is prevented.

The first valve body 71 is a bottomed cylindrical-shaped poppet valve and includes a hollow cylindrical portion 71a slidable along the first sliding hole 87a and a top portion 71b formed with a first valve portion 71c to be seated on a truncated conical first seat portion 88a provided in the first sliding hole 87a.

The second valve body 72 includes a sliding portion 72a slidable along the second sliding hole 87b, a supporting portion 72b extending from the sliding portion 72a and to be inserted into the hollow cylindrical portion 71a of the first valve body 71 and a through hole 72c penetrating in the axial direction. The first valve body 71 is slidably supported to displace along the sliding hole 87 by the supporting portion 72b of the second valve body 72.

The second valve body 72 further includes a poppet-like second valve portion 72e to be seated on a truncated conical second seat portion 88b formed in a step portion connecting the first and second sliding holes 87a, 87b. It should be noted that the first and second seat portions 88a, 88b may be directly formed in the sliding hole 87 or a member formed with truncated conical seat surfaces may be inserted and fixed in the sliding hole 87.

A first pressure chamber 78a is defined by the supporting portion 72b in the hollow cylindrical portion 71a of the first valve body 71. The pressure of the second port P2 is introduced to the first pressure chamber 78a through the through hole 72c and acts in a direction to close the first valve body 71. Further, a first spring 74 serving as a first biasing member for biasing the first valve body 71 in the valve closing direction is housed in a compressed state in the first pressure chamber 78a.

Here, a diameter D2 of the first pressure chamber 78a is preferably large to easily house the first spring 74 into the first pressure chamber 78a. However, since the pressure of the second port P2 is introduced to the first pressure chamber 78a through the through hole 72c, if the diameter D2 of the first pressure chamber 78a is larger than a diameter D1 of the first seat portion 88a, a force acting in the direction to close the first valve body 71 increases, wherefore it becomes difficult to open the first valve body 71.

Thus, the diameter D2 of the first pressure chamber 78a is preferably set smaller than the diameter D1 of the first seat portion 88a. In other words, the diameter D2 of the first pressure chamber 78a is set such that the area of a first pressure receiving surface A1 of the top portion 71b receiving the pressure of the first port P1 acting in the direction to open the first valve body 71 is larger than the area of a second pressure receiving surface A2 of the top portion 71b receiving the pressure of the first pressure chamber 78a with the first valve portion 71c of the first valve body 71 seated on the first seat portion 88a.

An annular second pressure chamber 78b is defined between the hollow cylindrical tube portion 71a of the first valve body 71 and the second valve portion 72e of the second valve body 72, and the pressure of the third port P3 is introduced thereto. An inner diameter of the second pressure chamber 78b is set equal to the diameter D2 of the first pressure chamber 78a and smaller than the diameter D1 of the first seat portion 88a as shown in FIG. 2. Thus, the pressure of the second pressure chamber 78b acts in the direction to open the second valve body 72 and also acts in the direction to close the first valve body 71 against the pressure of the first port P1 acting on the first pressure receiving surface A1.

A third pressure chamber 78c is defined between the second valve body 72 and the plug 73 and the pressure of the second port P2 is introduced thereto. A second spring 75 serving as a second biasing member is disposed in a compressed state in the third pressure chamber 78c. A biasing force of the second spring 75 and a pressure of the third pressure chamber 78c act in the direction to close the second valve body 72. As just described, the first and second springs 74, 75 are arranged such that biasing directions thereof are both directions along the sliding hole 87.

The first valve body 71 further includes a first communication hole 71d allowing communication between the first port P1 and the first pressure chamber 78a when the first valve portion 71c is separated from the first seat portion 88a. Further, the second valve body 72 further includes a second communication hole 72d allowing communication between the third port P3 and the through hole 72c when the second valve portion 72e is separated from the second seat portion 88b. The second communication hole 72d is not limited to the above configuration and may be any passage allowing communication between the third port P3 and the second port P2 when the second valve portion 72e is separated from the second seat portion 88b. For example, the second communication hole 72d may be a groove-like passage formed in the outer peripheral surface of the second valve body 72.

An O-ring 76 to be compressed between the supporting portion 72b and the hollow cylindrical tube portion 71a is arranged on the outer periphery of the supporting portion 72b of the second valve body 72. The communication between the first and second pressure chambers 78a, 78b through a clearance between the supporting portion 72b and the hollow cylindrical tube portion 71a is prevented by the O-ring 76. It should be noted that a backup ring may be arranged adjacent to the O-rings 76, 77 to suppress the protrusion of the O-rings 76, 77.

Next, the operation of the composite valve 70 is described.

The first valve body 71 compresses and moves the first spring 74 and is separated from the first seat portion 88a when the pressure of the first port P1 is higher than that of the third port P3 and becomes larger than that of the second port P2 by a predetermined value or larger. Specifically, the first valve portion 71c is separated from the first seat portion 88a when a force by the pressure of the first port P1 acting in the direction to open the first valve body 71 exceeds a force by the biasing force of the first spring 74 and the pressure of the first pressure chamber 78a acting in the direction to close the first valve body 71 in a state where the pressure of the first port P1 is higher than that of the third port P3. Then, the hydraulic oil is introduced from the first port P1 to the second port P2 through a clearance between the first valve portion 71c and the first seat portion 88a, the first communication hole 71d, the first pressure chamber 78a, the through hole 72c and the third pressure chamber 78c.

When the pressure of the second port P2 increases and the force by the biasing force of the first spring 74 and the pressure of the first pressure chamber 78a acting in the direction to close the first valve body 71 exceeds the force by the pressure of the first port P1 acting in the direction to open the first valve body 71 by introducing the hydraulic oil from the first port P1 to the second port P2, the first valve body 71 is seated on the first seat portion 88a and the communication between the first and second ports P1, P2 is blocked. In this way, the first valve body 71 allows only the flow of the hydraulic oil from the first port P1 to the second port P2 and prevents the back-flow thereof.

The second valve body 72 compresses and moves the second spring 75 and is separated from the second seat portion 88b when the pressure of the third port P3 is higher than that of the first port P1 and becomes larger than that of the second port P2 by a predetermined value or larger. Specifically, the second valve portion 72e is separated from the second seat portion 88b when a force by the pressure of the third port P3 acting in the direction to open the second valve body 72 exceeds a force by the biasing force of the second spring 75 and the pressure of the third pressure chamber 78c acting in the direction to close the second valve body 72 in a state where the pressure of the third port P3 is higher than that of the first port P1. Then, the hydraulic oil is introduced from the third port P3 to the second port P2 through a clearance between the second valve portion 72e and the second seat portion 88b, the second communication hole 72d, the through hole 72c and the third pressure chamber 78c.

When the pressure of the second port P2 increases and the force by the biasing force of the second spring 75 and the pressure of the third pressure chamber 78c acting in the direction to close the second valve body 72 exceeds the force by the pressure of the third port P3 acting in the direction to open the second valve body 72 by introducing the hydraulic oil from the third port P3 to the second port P2, the second valve body 72 is seated on the second seat portion 88b and the communication between the third and second ports P3, P2 is blocked. In this way, the second valve body 72 allows only the flow of the hydraulic oil from the third port P3 to the second port P2 and prevents the back-flow thereof.

Since the composite valve 70 operates as described above, the hydraulic oil in the main port 82 is introduced to the control pressure chamber 42 through the main port communication passage 84, the first valve body 71, the control pressure chamber communication passage 86 and the introducing hole 41 when the pressure of the main port 82 is higher than that of the sub-port 83. At this time, a flow from the control pressure chamber 42 to the sub-port 83 is blocked by the second valve body 72. On the other hand, if the pressure of the sub-port 83 is higher than that of the main port 82, the hydraulic oil in the sub-port 83 is introduced to the control pressure chamber 42 through the sub-port communication passage 85, the second valve body 72 and the introducing hole 41. At this time, a flow from the control pressure chamber 42 to the main port 82 is blocked by the first valve body 71.

It should be noted that the position of the second port P2 is not limited to a downstream side of the second valve body 72 and may be any position which is the downstream side of the second seat portion 88b and where the second port P2 can constantly communicate with the first and third pressure chambers 78a, 78c as shown by a broken line in FIG. 2. If the second port P2 is provided at this position, the hydraulic oil introduced from the first port P1 to the second port P2 flows through the second communication hole 72d. Further, by approaching the position of the second port P2 to that of the first port P1 in this way, an axial length becomes shorter and the composite valve 70 can be reduced in size.

Next, the operation of the solenoid valve 100 to supply the hydraulic oil from the pump to the actuator through the main port 82 and the sub-port 83 is described.

When no current is supplied to the coil 62, the plunger 33 is pressed by the biasing force of the sub-return spring 35, the sub-poppet valve 27a of the auxiliary valve 27 is seated on the sub-seat portion 26d and the control pressure chamber 42 is closed. In this state, the first valve body 71 is opened if the pressure in the control pressure chamber 42 is lower than the pressure of the main port 82. Then, the hydraulic oil in the main port 82 is introduced into the control pressure chamber 42 through the main port communication passage 84, the first communication hole 71d, the first pressure chamber 78a, the through hole 72c, the third pressure chamber 78c, the control pressure chamber communication passage 86 and the introducing hole 41, and the pressure in the control pressure chamber 42 becomes equal to that of the main port 82. As a result, the pressure equal to that of the main port 82 acts on the other end surface 22f of the main valve 22. That is, the pressure equal to that of the main port 82 acts on the valve closing pressure receiving surface S3.

Here, the area of the valve closing pressure receiving surface S3 on which the pressure in the control pressure chamber 42 acts is larger than the area of the first valve opening pressure receiving surface S1 on which the pressure of the main port 82 acts and the pressure of the sub-port 83 is sufficiently lower than that of the main port 82. Accordingly, the resultant force of the thrust force by the pressure in the control pressure chamber 42 acting on the valve closing pressure receiving surface S3 and the biasing force of the main return spring 24 exceeds the resultant force of the thrust force by the pressure of the main port 82 acting on the first valve opening pressure receiving surface S1 and the thrust force by the pressure of the sub-port 83 acting on the second valve opening pressure receiving surface S2, and the main valve 22 is biased in a direction to close the seat portion 13. As just described, when the coil 62 is in a non-energized state, the flow of the hydraulic oil from the main port 82 to the sub-port 83 is blocked.

On the other hand, when a current is supplied to the coil 62, the plunger 33 exceeds the biasing force of the sub-return spring 35 and is attracted toward the coil 62 by a thrust force generated by the solenoid portion 60. Then, the auxiliary valve 27 is displaced together with the plunger 33, whereby the sub-poppet valve 27a is separated from the sub-seat portion 26d and a clearance is formed between the sub-poppet valve 27a and the sub-seat portion 26d. The hydraulic oil in the control pressure chamber 42 passes through the first communication passage 23a, the second communication passage 23b and the communication holes 12b through this clearance and is discharged to the sub-port 83.

Since the inflow of the hydraulic oil from the main port 82 into the control pressure chamber 42 is limited by the introducing hole 41, the pressure in the control pressure chamber 42 decreases due to the communication between the control pressure chamber 42 and the sub-port 83. Then, the main valve 22 is displaced in a direction to open the seat portion 13 until the resultant force of the thrust force by the pressure in the control pressure chamber 42 acting on the valve closing pressure receiving surface S3 and the biasing force of the main return spring 24 and the resultant force of the thrust force by the pressure of the main port 82 acting on the first valve opening pressure receiving surface 51 and the thrust force by the pressure of the sub-port 83 acting on the second valve opening pressure receiving surface S2 are balanced. As a result, the hydraulic oil flows from the main port 82 to the sub-port 83 through clearances between the through holes 22d and the first seat portion 13a and between the poppet valve 22b and the second seat portion 13b and the communication holes 12b.

When the current supplied to the coil 62 is increased, the sub-poppet valve 27a is further separated from the sub-seat portion 26d. As a result, the amount of the hydraulic oil discharged from the control pressure chamber 42 to the sub-port 83 increases and the pressure in the control pressure chamber 42 further decreases. Then, the main valve 22 further moves in the direction to open the seat portion 13 according to a reduction in the pressure in the control pressure chamber 42, and the areas of the through holes 22d of the spool valve 22a exposed from the first seat portion 13a increase. As a result, a flow rate of the hydraulic oil flowing from the main port 82 to the sub-port 83 increases.

As just described, the flow rate of the hydraulic oil flowing from the main port 82 to the sub-port 83 is controlled by increasing and decreasing the current supplied to the coil 62 and controlling a displacement amount of the main valve 22.

When energization to the coil 62 is stopped, the thrust force for attracting the plunger 33 is lost. Thus, the plunger 33 is pressed in the direction to seat the sub-poppet valve 27a on the sub-seat portion 26d by the biasing force of the sub-return spring 35. When the sub-poppet valve 27a of the auxiliary valve 27 is seated on the sub-seat portion 26d, the hydraulic oil in the main port 82 is introduced into the control pressure chamber 42 through the introducing hole 41 and the pressure in the control pressure chamber 42 increases to become equal to the pressure of the main port 82.

When the pressure in the control pressure chamber 42 becomes equal to that of the main port 82, the resultant force of the thrust force by the pressure of the main port 82 acting on the first valve opening pressure receiving surface S1 and the thrust force by the pressure of the sub-port 83 acting on the second valve opening pressure receiving surface S2 falls below the resultant force of the thrust force by the pressure in the control pressure chamber 42 acting on the valve closing pressure receiving surface S3 and the biasing force of the main return spring 24. Thus, the main valve 22 is biased in the direction to close the seat portion 13. As a result, the main valve 22 is displaced in the direction to close the seat portion 13 and the flow of the hydraulic oil from the main port 82 to the sub-port 83 is blocked.

Next, a case is described where the pressure of the sub-port 83 increases more than the pressure of the main port 82.

If the pressure in the actuator increases such as due to an increase of a load acting on the actuator from outside after energization to the coil 62 is stopped and the supply of the hydraulic oil to the actuator is stopped, the pressure of the sub-port 83 communicating with the actuator also increases. Here, the pressure of the sub-port 83 acts on the step portion 22h of the main valve 22 in the direction to open the main valve 22 as shown in FIG. 1. Thus, if the pressure of the sub-port 83 increases more than the pressure in the control pressure chamber 42, the resultant force of the thrust force by the pressure of the main port 82 acting on the first valve opening pressure receiving surface S1 and the thrust force by the pressure of the sub-port 83 acting on the second valve opening pressure receiving surface S2 may exceed the resultant force of the thrust force by the pressure in the control pressure chamber 42 acting on the valve closing pressure receiving surface S3 and the biasing force of the main return spring 24, the main valve 22 may be opened and the hydraulic oil may flow out from the sub-port 83 to the main port 82.

In the solenoid valve 100 in the present embodiment, such a phenomenon can be suppressed by providing the second valve body 72 allowing only the flow of the hydraulic oil from the sub-port 83 to the control pressure chamber 42.

Specifically, if the pressure of the sub-port 83 becomes higher than the pressure of the main port 82 and the pressure in the control pressure chamber 42, the second valve body 72 is opened. Then, the hydraulic oil in the sub-port 83 is introduced into the control pressure chamber 42 through the sub-port communication passage 85, the second communication hole 72d, the through hole 72c, the third pressure chamber 78c, the control pressure chamber communication passage 86 and the introducing hole 41, and the pressure in the control pressure chamber 42 becomes equal to that of the sub-port 83.

Since the pressure in the control pressure chamber 42 becomes equal to that of the sub-port 83 as just described, even if the pressure of the sub-port 83 increases, a force acting in the direction to close the main valve 22 is constantly larger than a force acting in a direction to open the main valve 22. Thus, even if the pressure of the sub-port 83 becomes higher than that in the control pressure chamber 42, the main valve 22 is kept closed. Thus, the outflow of the hydraulic oil from the sub-port 83 to the main port 82 is prevented. As a result, displacement of the actuator due to an increase of a load or the like after stopping the supply of the hydraulic oil to the actuator is suppressed.

According to the above first embodiment, the following functions and effects are exhibited.

In the composite valve 70, two valve bodies, i.e. the first valve body 71 allowing only the flow of the hydraulic oil from the main port 82 to the control pressure chamber 42 and the second valve body 72 allowing only the flow of the hydraulic oil from the sub-port 83 to the control pressure chamber 42, are arranged in series in the sliding hole 87. That is, the two valve bodies are arranged in series in one flow passage. Thus, it is not necessary to provide a passage, in which a valve body is arranged, for each valve body, wherefore the composite valve 70 including the two valve bodies can be made compact and the solenoid valve 100 using the composite valve 70 can be made compact.

It should be noted that although the solenoid valve 100 in the first embodiment is a unidirectional flow control valve for controlling the flow rate of the hydraulic oil flowing from the main port 82 to the sub-port 83, the solenoid valve 100 may be a bidirectional flow control valve capable of controlling both the flow rate of the hydraulic oil flowing from the main port 82 to the sub-port 83 and the flow rate of the hydraulic oil flowing from the sub-port 83 to the main port 82. In this case, the solenoid valve 100 further includes a valve body capable of switching a discharge destination of the hydraulic oil discharged from the control pressure chamber 42 to the main port 82 or the sub-port 83 according to a flowing direction of the hydraulic oil.

### Second Embodiment

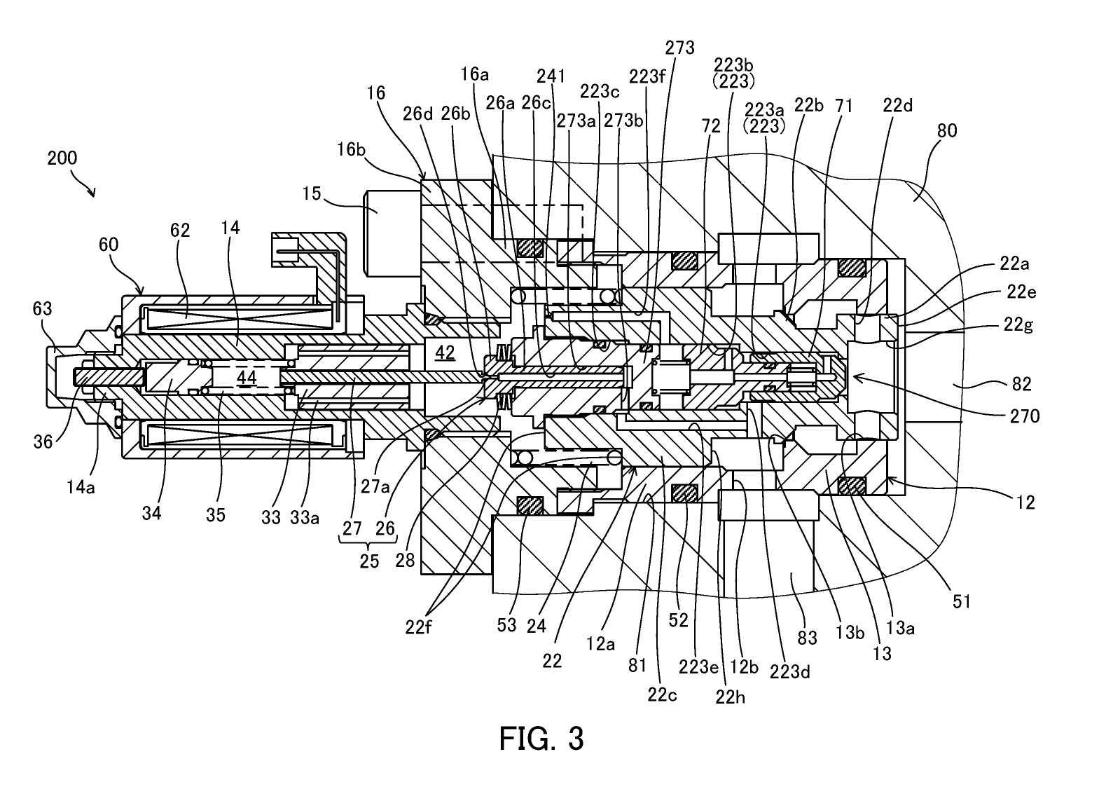

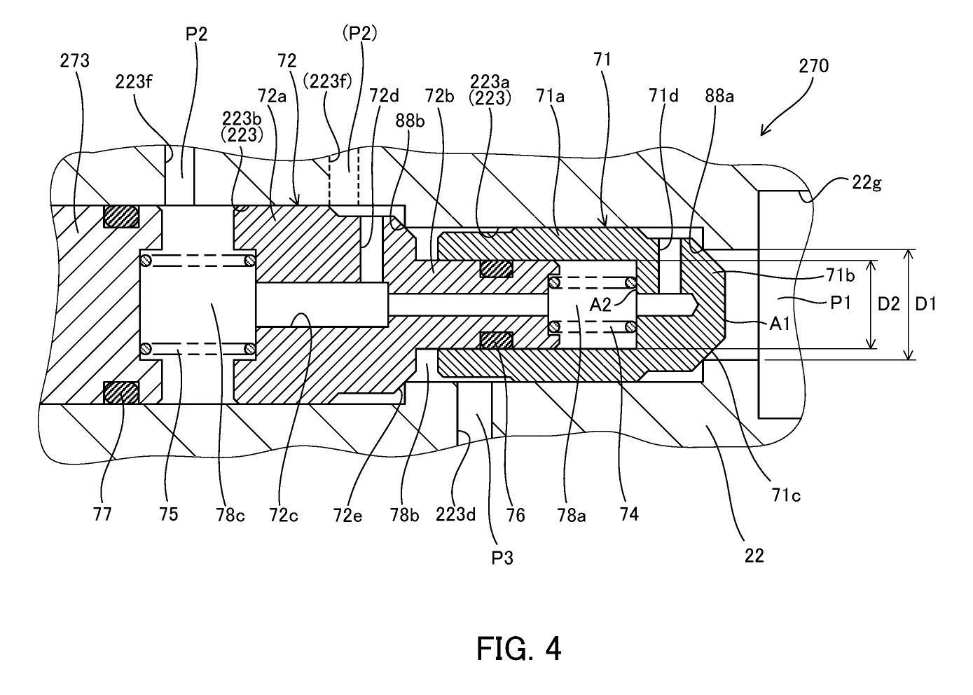

Next, a solenoid valve 200 according to a second embodiment of the present invention is described with reference to FIGS. 3 and 4. The following description is centered on points of difference from the first embodiment and components similar to those of the first embodiment are denoted by the same reference signs and not described.

Basic configurations of the solenoid valve 200 and a composite valve 270 are similar to those of the solenoid valve 100 and the composite valve 70 according to the first embodiment. The solenoid valve 200 differs from the solenoid valve 100 in that the composite valve 270 is built in a main valve 22.

The main valve 22 of the solenoid valve 200 is formed with a sliding hole 223 serving as a first flow passage in which a first valve body 71 and a second valve body 72 are slidably housed. The sliding hole 223 includes a first sliding hole 223a which is open in a recess 22g of the main valve 22 and in which the first valve body 71 is housed, and a second sliding hole 223b which is formed continuously with the first sliding hole 223a and in which the second valve body 72 is housed. An inner diameter of the second sliding hole 223b is formed to be larger than that of the first sliding hole 223a. Further, the first and second sliding holes 223a, 223b are formed such that center axes thereof coincide with that of the main valve 22.

The main valve 22 further includes a fixing hole 223c formed continuously with the second sliding hole 223b and opening in another end surface 22f. A plug 273 for closing the second sliding hole 223b is threadably engaged with and fixed to the fixing hole 223c. One end of the plug 273 is inserted into the second sliding hole 223b, and an O-ring 77 to be compressed between the plug 273 and the second sliding hole 223b is arranged on the outer periphery of the plug 273. The plug 273 is equivalent to the plug 73 in the first embodiment and a third pressure chamber 78c is defined between the second valve body 72 and the plug 273 as in the first embodiment.

The plug 273 includes a sliding hole 273a into which a sliding portion 26a of a pressure compensation sleeve 26 is slidably inserted and a communication hole 273b which allows communication between a through hole 26c of the pressure compensation sleeve 26 and a sub-port 83. The sliding hole 273a is a non-penetrating hole formed along an axial center of the plug 273, and the communication hole 273b is a through hole having one end communicating with the sliding hole 273a and the other end opening in the outer peripheral surface of the plug 273.

The main valve 22 further includes a sub-port communication passage 223d for allowing communication between a second pressure chamber 78b defined in the first sliding hole 223a and the sub-port 83, a communication passage 223e for allowing communication between the communication hole 273b and the sub-port communication passage 223d and a control pressure chamber communication passage 223f for allowing communication between the third pressure chamber 78c and a control pressure chamber 42 through an introducing hole 241 functioning as an orifice. In the second embodiment, the sub-port communication passage 223d corresponds to a second flow passage including a third port P3, a first port P1 is connected to a main port 82 through the recess 22g and a second port P2 is connected to the control pressure chamber 42 through the control pressure chamber communication passage 223f. The position of the second port P2 is not limited to the downstream side of the second valve body 72 and may be any position which is the downstream side of a second seat portion 88b and where the second port P2 can constantly communicate with first and third pressure chambers 78a, 78c as shown by a broken line in FIG. 4. If the second port P2 is provided at this position, hydraulic oil introduced from the first port P1 to the second port P2 flows through a second communication hole 72d. Further, by approaching the position of the second port P2 to that of the first port P1 in this way, an axial length of the main valve 22 can be shortened.

The composite valve 270 is similarly to the composite valve 70 of the first embodiment such that the first valve body 71 is opened if a pressure of the main port 82 is higher than that of the sub-port 83 and becomes larger than a pressure in the control pressure chamber 42 by a predetermined value or larger. When the first valve body 71 is opened, the hydraulic oil is introduced from the main port 82 to the control pressure chamber 42 through the recess 22g, a clearance between a first valve portion 71c and a first seat portion 88a, a first communication hole 71d, the first pressure chamber 78a, a through hole 72c, the third pressure chamber 78c, the introducing hole 241 and the control pressure chamber communication passage 223f.

Further, the composite valve 270 is similarly to the composite valve 70 of the first embodiment such that the second valve body 72 is opened if the pressure of the sub-port 83 is higher than that of the main port 82 and becomes larger than the pressure in the control pressure chamber 42 by a predetermined value or larger. When the second valve body 72 is opened, the hydraulic oil is introduced from the sub-port 83 to the control pressure chamber 42 through the sub-port communication passage 223d, the second pressure chamber 78b, a clearance between a second valve portion 72e and a second seat portion 88b, the second communication hole 72d, the through hole 72c, the third pressure chamber 78c, the introducing hole 241 and the control pressure chamber communication passage 223f.

Since the operation of the solenoid valve 200 is the same as the operation of the solenoid valve 100 of the first embodiment except that the hydraulic oil in the control pressure chamber 42 is discharged to the sub-port 83 through the through hole 26c, the sliding hole 273a, the communication hole 273b, the communication passage 223e, the sub-port communication passage 223d and communication holes 12b from a clearance between a sub-poppet valve 27a and a sub-seat portion 26d, the description thereof is omitted.

According to the above second embodiment, the following functions and effects are exhibited.

In the solenoid valve 200, two valve bodies, i.e. the first valve body 71 allowing only the flow of the hydraulic oil from the main port 82 to the control pressure chamber 42 and the second valve body 72 allowing only the flow of the hydraulic oil from the sub-port 83 to the control pressure chamber 42, are arranged in series in one sliding hole 223 formed in the main valve 22. Thus, it is not necessary to provide a passage, in which a valve body is arranged, for each valve body, and it is also not necessary to make an outer diameter of the main valve 22 larger in order to form a plurality of passages in which valve bodies are arranged. As a result, the solenoid valve 200 can be made compact.

The configurations, functions and effects of the embodiments of the present invention are summarily described below.

The composite valve 70, 270 includes the sliding hole 87, 223 having the first port P1 and the second port P2, the sub-port communication passage 85, 223d branched from the sliding hole 87, 223 and having the third port P3, the first valve body 71 allowing only the flow of the hydraulic oil from the first port P1 to the second port P2 and the second valve body 72 allowing only the flow of the hydraulic oil from the third port P3 to the second port P2. The first and second valve bodies 71, 72 are arranged in series in the sliding hole 87, 223, and the hydraulic oil is introduced from the first port P1 to the second port P2 through the through hole 72c provided in the second valve body 72 when the first valve body 71 is opened.

In this configuration, two valve bodies, i.e. the first valve body 71 allowing only the flow of the hydraulic oil from the main port 82 to the control pressure chamber 42 and the second valve body 72 allowing only the flow of the hydraulic oil from the sub-port 83 to the control pressure chamber 42 are arranged in series in one sliding hole 87, 223. Thus, it is not necessary to provide a passage, in which the valve body is arranged, for each valve body, wherefore the composite valve 70, 270 including the two valve bodies can be made compact and the solenoid valve 100, 200 using the composite valve 70, 270 can be made compact.

Further, the first valve body 71 includes the first valve portion 71c to be seated on the first seat portion 88a formed in the sliding hole 87, 223, the second valve body 72 includes the second valve portion 72e to be seated on the second seat portion 88b formed in the sliding hole 87, 223, and the first and second valve bodies 71, 72 are displaced along the sliding hole 87, 223.

In this configuration, both a displacing direction of the first valve body 71 and that of the second valve body 72 are directions along the sliding hole 87, 223. Since the displacing directions of the two valve bodies 71, 72 are the same as just described, the composite valve can be made compact as compared to the case where the displacing directions of the two valve bodies 71, 72 are different, e.g. the case where the displacing directions are perpendicular. Further, since the displacing directions are along the sliding hole 87, 223 in which the two valve bodies 71, 72 are arranged, the composite valve can be made compact as compared to the case where the displacing directions are at a predetermined angle with respect to the sliding hole 87, 223.

Further, the sliding hole 87, 223 is formed to be straight.

In this configuration, the sliding hole 87, 223 in which the first and second valve bodies 71, 72 are arranged is formed to be straight. Since the two valve bodies 71, 72 are arranged on one straight line, the composite valve can be made compact as compared to the case where the flow passage in which the two valve bodies 71, 72 are arranged is not straight.

Further, in the composite valve 70, 270, the first valve body 71 allows the flow of the hydraulic oil from the first port P1 to the second port P2 and the second valve body 72 blocks the flow of the hydraulic oil from the third port P3 to the second port P2 when the pressure of the first port P1 is higher than that of the third port P3 and becomes larger than that of the second port P2 by a predetermined value or larger. And in the composite valve 70, 270, the first valve body 71 blocks the flow of the hydraulic oil from the first port P1 to the second port P2 and the second valve body 72 allows the flow of the hydraulic oil from the third port P3 to the second port P2 when the pressure of the third port P3 is higher than that of the first port P1 and becomes larger than that of the second port P2 by a predetermined value or larger.

In this configuration, whether each of the first and second valve bodies 71, 72 allows or blocks the flow of the hydraulic oil is changed according to a pressure relationship of the first port P1, the second port P2, and the third port P3. As just described, in the composite valve 70, 270, a flowing state of the hydraulic oil can be changed according to the pressure of each port P1, P2, P3.

Further, the second valve body 72 includes the sliding portion 72a which is slidable along the sliding hole 87, 223 and the supporting portion 72b which projects from the sliding portion 72a and slidably supports the first valve body 71. The first valve body 71 includes the hollow cylindrical portion 71a which is slidably provided along the sliding hole 87, 223 and into which the supporting portion 72b of the second valve body 72 is inserted.

In this configuration, the first valve body 71 is supported by the supporting portion 72b of the second valve body 72. Since the first and second valve bodies 71, 72 are adjacently arranged in the axial direction as just described, the composite valve can be made compact.

Further, the composite valve 70, 270 further includes the second spring 75 biasing the second valve body 72 in the valve closing direction and the first spring 74 interposed between the first valve body 71 and the supporting portion 72b and biasing the first valve body 71 in the valve closing direction, and both the biasing direction of the first spring 74 and that of the second spring 75 are directions along the sliding hole 87, 223.

In this configuration, both the biasing direction of the first valve body 71 and that of the second valve body 72 are directions along the sliding hole 87, 223. Since the biasing directions of the two valve bodies 71, 72 are the same, the composite valve can be made compact as compared to the case where the biasing directions of the two valve bodies 71, 72 are different, e.g. the case where the biasing directions are perpendicular. Further, since the biasing directions are along the sliding hole 87, 223 in which the two valve bodies 71, 72 are arranged, the composite valve can be made compact as compared to the case where the biasing directions are at a predetermined angle with respect to the sliding hole 87, 223.

Further, the second valve portion 72e is provided between the sliding portion 72a and the supporting portion 72b. The second pressure chamber 78b to which the pressure of the third port P3 is introduced to bias the first valve body 71 in the valve closing direction is formed between the hollow cylindrical portion 71a of the first valve body 71 and the second valve portion 72e of the second valve body 72.

In this configuration, the second pressure chamber 78b to which the pressure of the third port P3 is introduced is provided between the hollow cylindrical portion 71a of the first valve body 71 and the second valve portion 72e of the second valve body 72. Thus, when the pressure of the third port P3 is higher than that of the first port P1, a force for biasing the first valve body 71 in the valve closing direction becomes larger and the outflow of the hydraulic oil from the third port P3 to the first port P1 can be prevented. On the other hand, when the pressure of the third port P3 is lower than that of the first port P1, the force for biasing the first valve body 71 in the valve closing direction becomes smaller, wherefore an influence on the valve opening operation of the first valve body 71 becomes smaller.

Further, the O-ring 76 to be compressed between the supporting portion 72b and the hollow cylindrical portion 71a is arranged on the outer periphery of the supporting portion 72b.

In this configuration, the O-ring 76 to be compressed between the supporting portion 72b and the hollow cylindrical portion 71a is provided. Thus, the leakage of the hydraulic oil introduced from the first port P1 into the hollow cylindrical portion 71a to the third port P3 through the clearance between the supporting portion 72b and the hollow cylindrical portion 71a can be prevented.

Further, the first valve portion 71c and the second valve portion 72e are poppet valves to be respectively seated on the first seat portion 88a and the second seat portion 88b formed into a truncated conical shape.

In this configuration, the first and second valve bodies 71, 72 are formed as the poppet valves. Thus, the flow of the hydraulic oil between each pair of the ports P1 to P3 can be reliably blocked by each valve body 71, 72 being seated on each seat portion 88a, 88b.

Further, the solenoid valve 100, 200 for controlling the flow rate of the hydraulic oil flowing between the main port 82 and the sub-port 83 includes the main valve 22 changing a communication opening degree between the main port 82 and the sub-port 83, the control pressure chamber 42 biasing the main valve 22 in the valve closing direction by the hydraulic oil being introduced thereto from the main port 82 or the sub-port 83 through the aforementioned composite valve 70, 270, and the solenoid portion 60 controlling the pressure in the control pressure chamber 42. The composite valve 70, 270 is arranged such that the first port P1 communicates with the main port 82, the second port P2 communicates with the control pressure chamber 42, and the third port P3 communicates with the sub-port 83.

In this configuration, the composite valve 70, 270 is arranged such that the first port P1 communicates with the main port 82, the second port P2 communicates with the control pressure chamber 42, and the third port P3 communicates with the sub-port 83. Since the composite valve 70, 270 made compact is arranged with respect to the solenoid valve 100, 200 in this way, the solenoid valve 100, 200 can be reduced in size.

Further, the composite valve 270 is built in the main valve 22.

In this configuration, two valve bodies, i.e. the first valve body 71 allowing only the flow of the hydraulic oil from the main port 82 to the control pressure chamber 42 and the second valve body 72 allowing only the flow of the hydraulic oil from the sub-port 83 to the control pressure chamber 42 are arranged in series in the sliding hole 223 formed in the main valve 22. Since it is not necessary to provide separate passages by increasing the outer diameter of the main valve 22 to arrange the two valve bodies as just described, the solenoid valve 200 can be made compact.

Further, the composite valve 270 is provided in the main valve 22 such that the center axis of the sliding hole 223 coincides with that of the main valve 22.

In this configuration, the center axis of the sliding hole 223 coincides with that of the main valve 22. Thus, the sliding hole 223 can be simultaneously processed in processing the recess 22g of the main valve 22 or the like. As a result, it is possible to improve the processing accuracy and reduce processing cost of the sliding hole 223.

The embodiments of the present invention described above are merely illustration of some application examples of the present invention and not of the nature to limit the technical scope of the present invention to the specific constructions of the above embodiments.

For example, although the composite valve 70, 270 is applied to the solenoid valve 100, 200 in the above embodiments, there is no limitation to this and a composite valve can be applied to any device if it is necessary to control the flow of working fluid between three ports.

The present application claims a priority based on Japanese Patent Application No. 2015-175891 filed with the Japan Patent Office on Sep. 7, 2015, all the contents of which are hereby incorporated by reference.

1. A composite valve comprising:
a first flow passage connecting a first port and a second port, the first flow passage being formed to be straight;
a second flow passage branched from the first flow passage, the second flow passage including a third port;
a first valve body configured to allow only the flow of working fluid from the first port to the second port; and
a second valve body configured to allow only the flow of the working fluid from the third port to the second port, wherein
the first valve body includes a first valve portion configured to be seated on a first seat portion formed in the first flow passage,
the second valve body includes a second valve portion configured to be seated on a second seat portion formed in the first flow passage,
the first valve body and the second valve body are displaced along the first flow passage, and
the working fluid is introduced from the first port to the second port through a through hole provided in the second valve body when the first valve body is opened.

2. The composite valve according to claim 1, wherein
the first valve body allows the flow of the working fluid from the first port to the second port and the second valve body blocks the flow of the working fluid from the third port to the second port when a pressure of the first port is higher than a pressure of the third port and becomes larger than a pressure of the second port by a predetermined value or larger, and
the first valve body blocks the flow of the working fluid from the first port to the second port and the second valve body allows the flow of the working fluid from the third port to the second port when the pressure of the third port is higher than the pressure of the first port and becomes larger than the pressure of the second port by a predetermined value or larger.

3. The composite valve according to claim 1, wherein
the second valve body includes a sliding portion slidable along the first flow passage and a supporting portion projecting from the sliding portion, the supporting portion slidably supporting the first valve body, and
the first valve body includes a hollow cylindrical portion slidably provided along the first flow passage, the supporting portion of the second valve body being inserted into the hollow cylindrical portion.

4. The composite valve according to claim 3, wherein
the second valve portion is provided between the sliding portion and the supporting portion, and
a second pressure chamber is formed between the hollow cylindrical portion of the first valve body and the second valve portion of the second valve body, the pressure of the third port being introduced to the second pressure chamber to bias the first valve body in a valve closing direction.

5. A solenoid valve including the composite valve according to claim 1, the solenoid valve being configured to control a flow rate of working fluid flowing between a main port and a sub-port, comprising:
a main valve configured to change a communication opening degree between the main port and the sub-port;
a control pressure chamber configured to bias the main valve in a valve closing direction by the working fluid being introduced to the control pressure chamber from the main port or the sub-port through the composite valve; and
a solenoid portion configured to control a pressure in the control pressure chamber, wherein
the composite valve is arranged such that the first port communicates with the main port, the second port communicates with the control pressure chamber, and the third port communicates with the sub-port.

6. The solenoid valve according to claim 5, wherein
the composite valve is built in the main valve.

7. The solenoid valve according to claim 6, wherein
the composite valve is provided in the main valve such that a center axis of the first flow passage coincides with a center axis of the main valve.
